(19) United States
(12) Patent Application Publication
(10) Pub. No.: US 2008/0226082 A1
(43) Pub. Date: Sep. 18, 2008

(54) Systems and methods for secure data backup

(75) Inventors: Jeffrey Brunet, Richmond Hill (CA); Ian Collins, Markham (CA); Yousuf Chowdhary, Maple (CA)

Correspondence Address: Gard and Kaslow, LLP, One 1st Street, Suite 9, Los Altos, CA, 94022, US

(73) Assignee: Storage Appliance Corporation

(21) Appl. No.: 12/075,727

(22) Filed: Mar. 12, 2008

Related U.S. Application Data
(60) Provisional application No. 60/906,244, filed on Mar. 12, 2007.

(51) Int. Cl. H04L 9/14

(52) U.S. Cl. 380/277; 713/193

(57) ABSTRACT

Systems and methods are provided for securely backing up data files of a computing system onto a backup device. An encryption key is generated using some identification found on and unique to the computing system. The encryption key is used to encrypt the data which is then stored on the backup device as encrypted backed up data. The encrypted backed up data stored on the backup device can later be accessed, e.g., for data recovery purposes, by once again using the computing system unique identification to generate the encryption key which can then be used to decrypt the encrypted backed up data. In this way, the backed up data remains secure even if the backup device is lost or stolen.

### CROSS-REFERENCE TO RELATED APPLICATIONS

This application claims the benefit of U.S. Provisional Patent Application No. 60/906,244 filed on Mar. 12, 2007 and entitled “A Method and System for Securely Binding a Backup Appliance to a Trusted Environment.” This application is related to U.S. patent application Ser. No. 11/506,386 filed on Aug. 18, 2006 and entitled “Data Backup Devices and Methods for Backing up Data” which is a divisional application of U.S. patent application Ser. No. 11/492,380 filed on Jul. 24, 2006 and entitled “Emulation Component for Data Backup Applications.” This application is also related to U.S. patent application Ser. No. 11/546,176 filed on Oct. 10, 2006 and entitled “Optical Disc Initiated Data Backup.” This application is also related to U.S. patent application Ser. No. 11/601,040 filed on Nov. 16, 2006 and entitled “Methods for Selectively Copying Data Files to Networked Storage and Devices for Initiating the Same” which is also a Continuation-in-Part of U.S. patent application Ser. Nos. 11/506,386 and 11/546,176. Each of the aforementioned applications is incorporated herein by reference.

### BACKGROUND OF THE INVENTION

1. Field of the Invention

The present invention relates generally to the field of backing up digital content and more particularly to providing security for the backed up content.

2. Description of the Prior Art

Data security is an ever increasing problem. As the volume of digital data and the number of devices, systems and media containing digital data has increased, the risk of inadvertent or unwanted exposure of digital data has likewise increased. This risk is heightened when digital data is backed up to another device or media because this provides yet another opportunity for such exposure. A backed up copy of one's digital data may be as accessible as the device or media onto which the data has been backed up. What is needed is a way to ensure that the backed up data can remain secure even if the device or media itself becomes accessible by others.

### SUMMARY

An exemplary method of the invention comprises locating, on a first computing system, identification unique to the first computing system, creating a first encryption key using the located first computing system unique identification, storing the first encryption key on a backup device, encrypting, using the first encryption key, a data file from the first computing system, and storing the encrypted data file from the first computing system on the backup device.

In some embodiments, the method further comprises locating again, on the first computing system, identification unique to the first computing system, creating a second encryption key using the again located computing system unique identification, and decrypting, using either the first encryption key or the second encryption key, the encrypted data file from the first computing system stored on the backup device if the second encryption key matches the first encryption key stored on the backup device.

In still further embodiments, the method further comprises storing the first encryption key on an external source.

In yet further embodiments, the method further comprises locating, on a second computing system, identification unique to the second computing system, creating a second encryption key using the located second computing system unique identification, obtaining the first encryption key from the external source, if the second encryption key does not match the first encryption key stored on the backup device, and decrypting, using the obtained first encryption key, the encrypted data file from the first computing system stored on the backup device.

In yet still further embodiments, the method further comprises storing the second encryption key on the backup device, encrypting, using the second encryption key, a data file from the second computing system, and storing the encrypted data file from the second computing system on the backup device.

The present invention also provides a computer readable medium having stored thereupon computing instructions. The computing instructions comprise a code segment to locate, on a first computing system, identification unique to the first computing system, a code segment to create a first encryption key using the located first computing system unique identification, a code segment to store the first encryption key on a backup device, a code segment to encrypt, using the first encryption key, a data file from the first computing system, and a code segment to store the encrypted data file from the first computing system on the backup device.

An exemplary backup device of the present invention comprises a computer readable medium having stored thereupon computing instructions. The computing instructions include a code segment to locate, on a first computing system, identification unique to the first computing system, a code segment to create a first encryption key using the located first computing system unique identification, a code segment to store the first encryption key on a backup device, a code segment to encrypt, using the first encryption key, a data file from the first computing system, and a code segment to store the encrypted data file from the first computing system on the backup device.

### BRIEF DESCRIPTION OF DRAWINGS

FIG. 1 shows data files of a computing system being backed up to a backup device and then being restored to the computing system according to an embodiment of the present invention.

FIG. 2 shows data files of a computing system being backed up to a backup device and then being copied to another computing system according to an embodiment of the present invention.

FIG. 3 shows a flowchart representation of a method for securely backing up data files and accessing the data files according to various embodiments of the present invention.

FIG. 4 shows a backup device according to an embodiment of the present invention.

FIG. 5 shows a backup device according to another embodiment of the present invention.

FIG. 6 shows a backup device according to another embodiment of the present invention.

FIG. 7 shows a computing system with an internal optical drive and an attached external optical drive for receiving the backup device of FIG. 6 according to an embodiment of the present invention.

FIG. 8 shows a backup device according to another embodiment of the present invention.

### DETAILED DESCRIPTION OF THE INVENTION

The present invention is directed to systems and methods for securely backing up data from a computing system onto a backup device. An encryption key is generated using some identification found on and unique to the computing system. The encryption key is used to encrypt the data which is then stored on the backup device as encrypted backed up data. The encrypted backed up data stored on the backup device can later be accessed, e.g., for data recovery purposes, by once again using the computing system unique identification to generate the encryption key which can then be used to decrypt the encrypted backed up data. Optionally, the encryption key can also be stored on an external source, as described further herein.

Using another computing system to access the encrypted backed up data generally results in failure in that a different encryption key, generated using identification found on the other computing system, will not properly decrypt the backed up data thus maintaining its security.

However, if the encryption key generated from the first computing system was stored on an external source, it can be obtained from that external source and used in decrypting the backed up data using another computing system. Security is maintained by controlling access to the external source.

The systems and methods described herein can be used, for instance, to augment backup applications to provide security for the backed up data. In particular, these systems and methods can be used in conjunction with the backup systems and methods disclosed in the several related applications listed above.

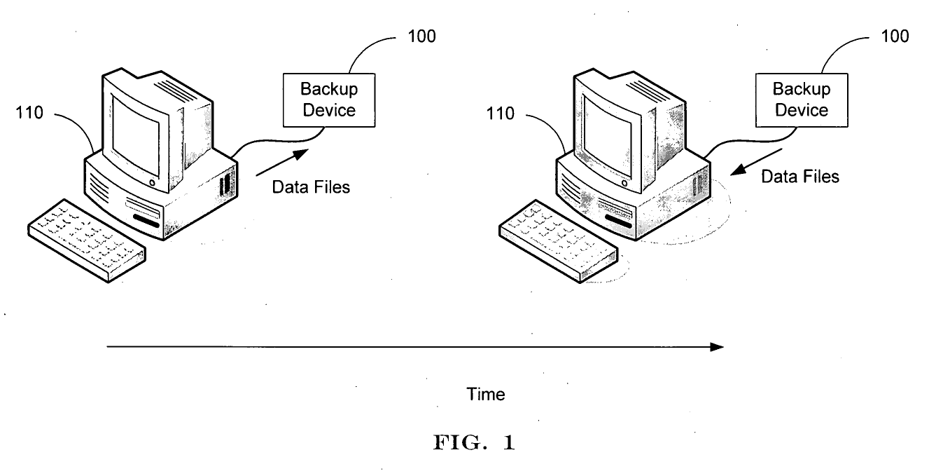

FIG. 1 shows data files of a computing system being securely backed up to a backup device and then being restored to the computing system according to an embodiment of the present invention. In FIG. 1 a backup device 100 is coupled to a computing system 110 and data files are securely backed up from the computing system 110 to the backup device 100. Various examples of the backup device 110 are described in greater detail elsewhere herein. The computing system 110, as used herein, can be any system comprising a processor and memory and is not limited to a computer such as a desktop or laptop unit. Accordingly, computing system 110 can include other electronic systems and devices such as cell phones, personal digital assistants, automobile navigation systems and video game consoles, among many other possibilities. Data to be securely backed up encompasses any digital content found on the computing system and, as desired, can be limited to certain types of digital content such as pictures, video, music, etc.

The data being backed up onto the backup device 100 is encrypted to maintain its security. The encryption is performed with an encryption key unique to the computing system 110 because the encryption key is generated from identification unique to the computing system. In this way, a relationship or binding is established between the computing system 110 and the encrypted backed up data on the backup device 100.

The identification unique to the computing system can be any alphanumeric sequence existing on the computing system such as computing system serial number, microprocessor serial number, memory device (e.g., disk drive) serial number, operating system serial number, etc., or any combination or variant thereof.

At a later point in time the encrypted backed up data can be stored back to the computing system 110 from the backup device 100 thus restoring the data of the computing system 110. A user might seek to restore the data to the computing system 110 following the accidental modification or erasure of the data on the computer system 110 as well as after the loss of the data from the computing system 110 due to a computer virus or other malicious attack. It will be understood that the backup device 100 need not remain connected to the computing system 110 during the period between backing up the data and later restoring the data to the computing system 110.

Storing the backed up data from the backup device 100 to the computing system 110 involves decrypting the encrypted backed up data using an encryption key. The identification unique to the computing system 110 is again used to create the encryption key. However, if a user tries to store the encrypted backed up data from the backup device 100 to some other computing system, then identification unique to that other computing system would generate a different encryption key which would not properly decrypt the backed up data. In this way, the encrypted backed up data remains secure even if the backup device 100 containing the backed up data is lost or stolen.

Optionally, the encryption key created when the backed up data is encrypted and stored on the backup device 100 can also be stored on some external source. The external source may be a removable storage device such as a flash memory based “thumb drive.” Alternatively, the external source may be another computing system or server coupled to the computing system via a local area network, wide area network or the internet.

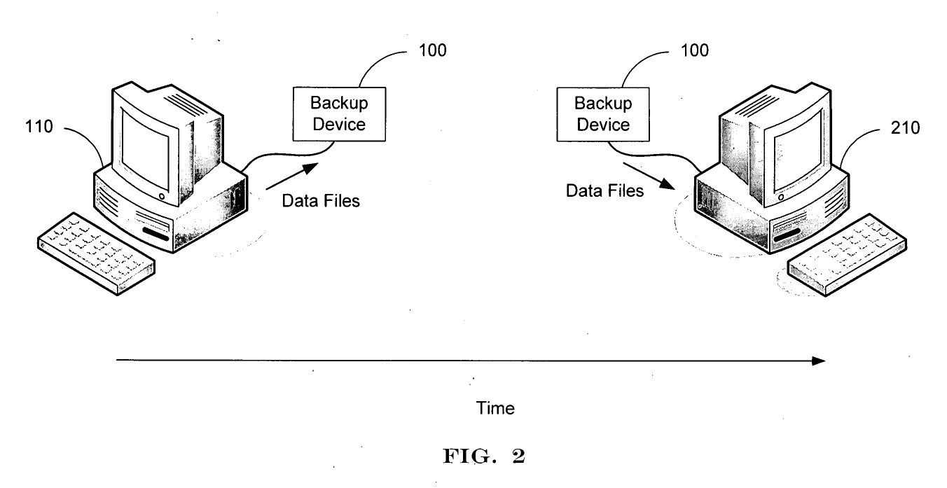

Another possible use of the invention is illustrated generally by FIG. 2. Here, the backup device 100 is coupled to the computing system 110 and the data is backed up from the computing system 110 to the backup device 100. Subsequently, the user may wish to copy the backed up data to another computing system 210. This may occur when, for example, the computing system 110 of FIG. 1 is unavailable or is inoperable for some reason. Copying the backed up data to another computing system 210 is accomplished by obtaining the encryption key from an external source, either not shown in the figure or which may be the other computing system 210 itself, as described further herein.

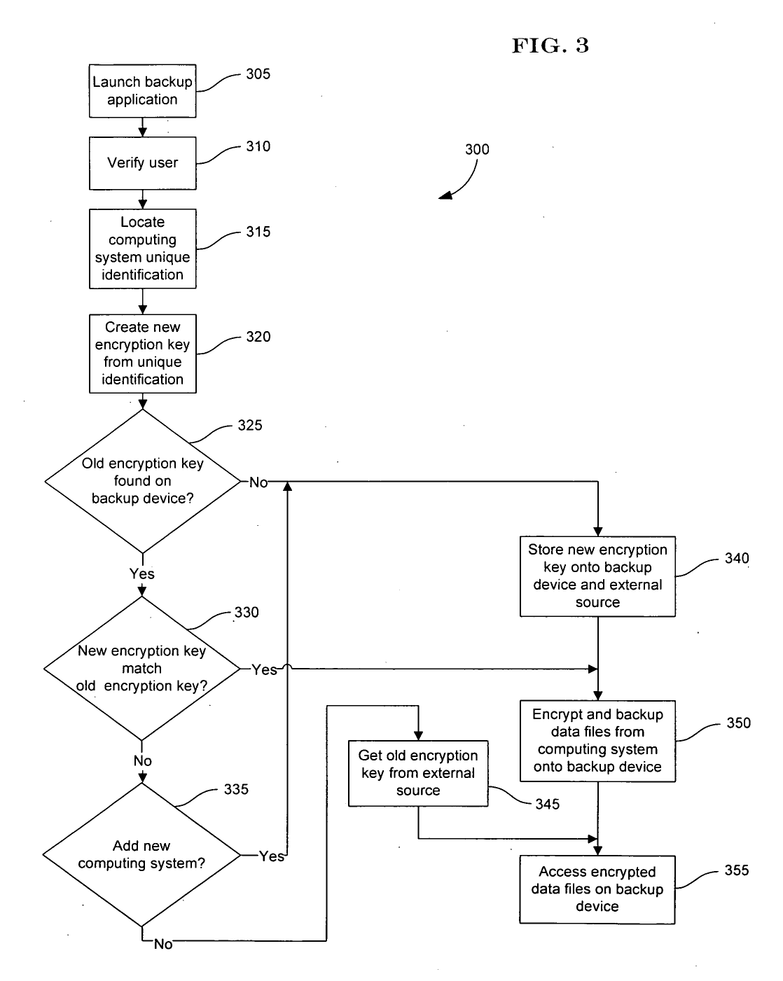

FIG. 3 shows a flowchart representation of an exemplary method 300 for securely backing up a data file from a computing system onto a backup device. The method 300 also describes optional steps of user verification, accessing the encrypted backed data, and backing up data from another computing system, all as described further herein. The method 300 can be performed, for example, by logic of the computing system 110 (FIG. 1) such as software, firmware, hardware or a combination thereof. As one example, the method 300 can be performed by software comprising a backup application such as described in the various patent applications listed herein as related applications. Method 300 comprises launching a backup application 305, optionally performing a user verification 310, locating unique identification of a computing system 315, creating an encryption key from the unique identification 320, and, depending upon various determinations, storing the encryption key onto a backup device and an external source, encrypting and backing up data files from the computing system to the backup device, getting an encryption key from an external source, and accessing the encrypted data files on the backup device. The method 300 can further comprise additional and alternative optional steps as discussed further herein.

Launching the backup application in step 305 may be triggered by an auto-launch operation as described in the various patent applications listed herein as related applications. Alternatively, the backup application may be launched in the same manner as launching any other computing system application as is known in the art.

The backup application optionally verifies a user in step 310 by requesting a user of the computing system or backup device to enter a password and confirming that it matches a previously entered password. Password creation and user verification can follow any standard approach as is known by one of ordinary skill in the art. Alternative known forms of user verification may likewise be used such as biometrics, etc.

A unique identification of the computing system is then located on or within the computing system in step 315. This may involve reading one or more identification on the computing system. An encryption key is created in step 320 using the located computing system identification. Creation of the encryption key can be performed using any process known in the art.

The backup device is then checked, in step 325, for a previously stored encryption key. If no encryption key is found on the backup device, which would typically indicate that the backup device has not previously been used with the present invention, the encryption key created in step 320 is stored, in step 340, onto the backup device and onto an external source such as a flash memory based device (e.g., a thumb drive) or to a networked computing system as described further herein.

In step 350, the encryption key is then used to encrypt the data being backed up by the backup application and the encrypted data is stored on the backup device. Using the encryption key to encrypt the data being backed up can follow any known encryption approach known in the art.

The encryption key can then be used in step 355 to access the encrypted data stored on the backup device by decrypting the encrypted data using the encryption key, as known in the art. Such access may occur when, for example, a user requests data recovery from the backup device according to a typical backup recovery operation.

Returning to step 325, if an encryption key is found on the backup device, which would typically indicate that the backup device has previously been used with the present invention, a determination is made in step 330 regarding whether the encryption key created in step 320 matches the encryption key found on the backup device. If they match, which would typically indicate a binding of data already backed up on the backup device with the particular computing system, then in an optional step 350 a backup operation is performed including encrypting data being backed up from the computing system and storing the encrypted data onto the backup device. Note that in some situations, such as when accessing already backed up data is the desired result rather than backing up any additional data, step 350 may be skipped.

Finally, the encryption key (either the encryption key created in step 320 or the encryption key stored on the backup device) can then be used in step 355 to access the encrypted data stored on the backup device by decrypting the encrypted data using the encryption key. This access may be for a variety of reasons such as restoring the backed up data to the computing system, simply to read, view or listen to the backed up data, etc.

Returning to step 330, if the encryption key created in step 320 does not match the encryption key found on the backup device, which would typically indicate no previous binding of the backed up data on the backup device with the particular computing system, a determination is made in step 355 as to whether this particular computing system should be added to those being backed up to the backup device (i.e., establishing a binding relationship with this particular computing system). This determination can be made by posing a query to the user in the form of a dialogue box or other known means for a user to indicate their choice of action. If this particular computing system is to be added then the process continues as described above by storing the new encryption key in step 340, encrypting and backing up data files from this particular computing system onto the backup device in step 350, and optionally accessing the encrypted backed up data files on the backup device by decrypting the encrypted data using the new encryption key in step 355.

Alternatively, if the determination made in step 355 is that this particular computing system is not to be added to those being backed up to the backup device (i.e., no new binding is to be established) and instead, for example, the user merely wishes to access previously encrypted and backed up data on the backup device using this particular computing system then, in step 345, the old encryption key is obtained from an external source. As described elsewhere, this may involve asking the user to connect a thumbdrive to the computing system or backup device, providing an address or link to a networked location where the encryption can be found, or simply reading the encryption key from this particular computing system where it was previously stored. Finally, in step 355, the encrypted backed up data files on the backup device are accessed by decrypting them using the obtained encryption key.

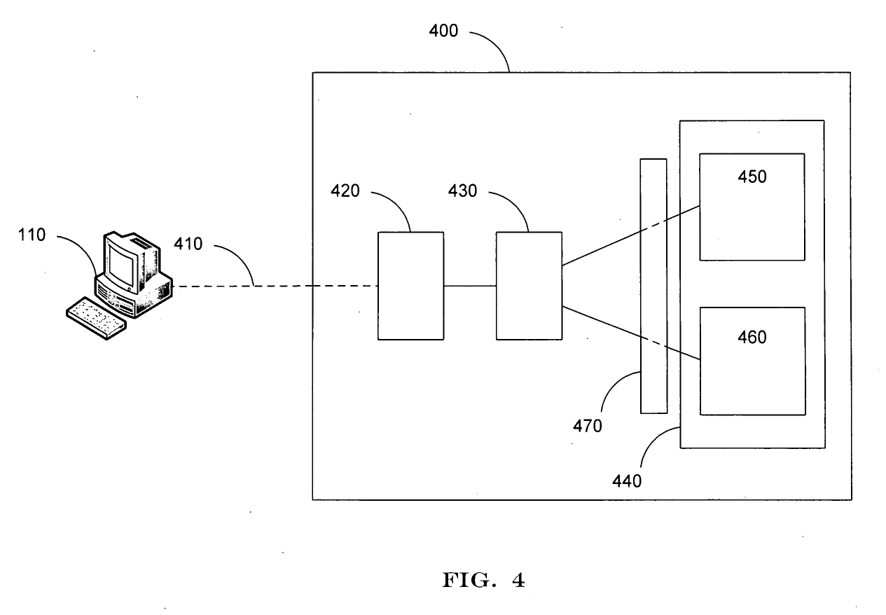

The present invention is also directed to a backup device 100 (FIG. 1) that can comprise a computer readable medium having stored thereon computing instructions for performing the various methods of the invention. Examples of different backup devices are described below with respect to FIGS. 4-6 and 8. FIG. 4 shows a schematic representation of an exemplary backup device 400 connected to a computing system 110 by a connection 410, using technology as disclosed in U.S. patent application Ser. No. 11/506,386. The backup device 400 comprises a communication interface 420, an emulation component 430, and a computer readable medium 440 that includes a first logical storage area 450 and second logical storage area 460. The computer readable medium 440 can be, for example, a hard disk drive (HDD) that has been partitioned into at least two logical storage areas. Other suitable computer readable media 440 are solid-state memory devices, such as Secure Digital (SD) memory cards and CompactFlash (CF) memory cards. The computer readable medium 440 can also be implemented by two different devices, one dedicated to each of the two logical storage areas 450, 460. In some embodiments, the backup device 400 further comprises a memory device interface 470 that allows the first and second logical storage areas 450 and 460 to communicate with the emulation component 430.

The first logical storage area 450 represents a logical area of the computer readable medium 440 that is meant to be inaccessible to the user and safe from accidental erasure. The first logical storage area 450 can contain, for example, a backup application, a look-up table, system files, drivers, and other setup and configuration software. The first logical storage area 450 is represented to the computing system 110 by the emulation component 430 as being an auto-launch device. As used herein, auto-launch devices are those devices that will trigger the automatic execution functionalities of certain operating systems, such as the AutoRun function of the Microsoft Windows operating system.

The second logical storage area 460 represents a logical area of the computer readable medium 440 that is dedicated to storing backed-up data files. Accordingly, the emulation component 430 represents the second logical storage area 460 to the computing system 110 as being a writable computer readable medium. With reference to FIG. 1, where the backup device 100 more specifically comprises the backup device 400, the backup application can be launched automatically when the backup device 400 is connected to the computing system 110. The backup application can then perform a method described herein to back up a data file to the second logical storage area 460.

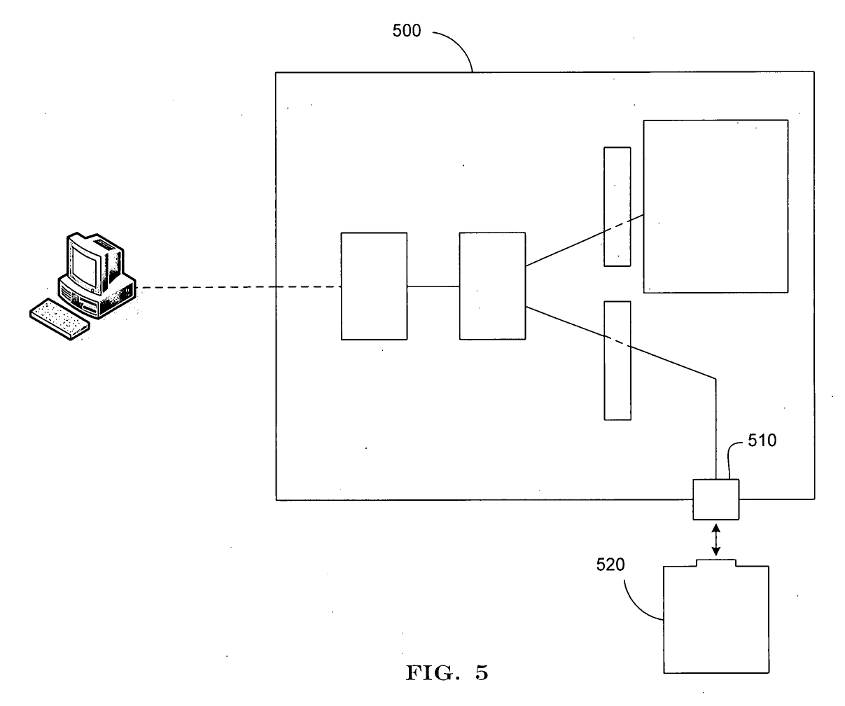

FIG. 5 shows a schematic representation of another exemplary backup device 500 similar to backup device 400 but without the second logical storage area 460 (FIG. 4). In place of the second logical storage area 460, the backup device 500 comprises a communication port 510 to allow a removable storage device 520, such as a SD or FC memory card or HDD, to be attached externally to the backup device 500. Thus, data files can be backed up to the removable storage device 520.

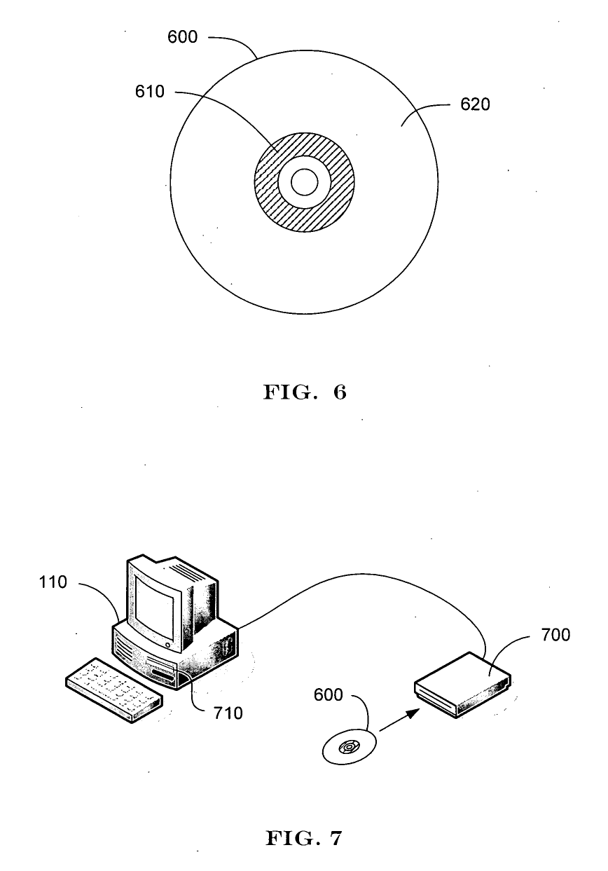

FIG. 6 shows a schematic representation of an exemplary backup device 600 using technology as disclosed in U.S. patent application Ser. No. 11/546,176. The backup device 600 comprises an optical disc having two portions, a read-only portion 610 and a writable portion 620. The portions 610, 620 can comprise either the same or different media formats. The read-only portion 610 includes computer-readable instructions for backing up data files onto the writable portion 620. These computer-readable instructions can include, for example, a backup application.

FIG. 7 shows a computing system 110 connected to an external optical drive 700 for reading from and writing to the backup device 600. The computing system 110 can alternatively or additionally include an internal optical drive 710 for the same purpose. When the backup device 600 is inserted into either of the optical drives 700, 710, the operating system of the computing system 110 can automatically launch the backup application to then perform a method described herein to back up data files to the writable portion 620 (FIG. 6).

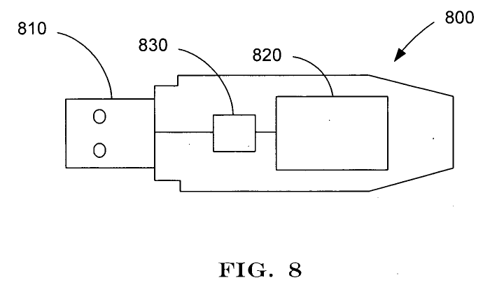

FIG. 8 shows a schematic representation of an exemplary backup device 800 using technology as disclosed in U.S. patent application Ser. No. 11/601,040. The backup device 800 comprises a USB interface 810. The backup device 800 can be, for example, a USB flash drive (UFD) such as a key drive, pen drive, jump drive, thumb drive, a memory stick, or the like. The backup device 800 also comprises a flash memory 820 and an emulation component 830 in communication between the flash memory 820 and the USB interface 810. The flash memory 820 includes computer-readable instructions comprising, for example, a backup application. The backup application, when executed, is configured to perform a method of the invention described herein to copy a data file from a computing system 110 (FIG. 1) to, for example, the flash memory 820. When the backup device 800 is connected to a USB interface of the computing system 110, the operating system of the computing system 110 can recognize the backup device 800 as an auto-launch device, because of the emulation component 830, and automatically launch the backup application.

It will be appreciated that the Windows Vista operating system allows devices to designate themselves as auto-launching. The emulation components 430, 830 in the backup devices 400, 500, and 800 are therefore optional in those embodiments where these backup devices will be used with Windows Vista or some other operating system that provides similar functionality. In these embodiments, because the backup device can designate itself as auto-launching, the backup application can auto-launch.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A secure backup method comprising:
locating, on a first computing system, identification unique to the first computing system;
creating a first encryption key using the located first computing system unique identification;
storing the first encryption key on a backup device;
encrypting, using the first encryption key, a data file from the first computing system; and
storing the encrypted data file from the first computing system on the backup device.

2. The method of claim 1, further comprising:
locating again, on the first computing system, identification unique to the first computing system;
creating a second encryption key using the again located computing system unique identification; and
decrypting, using either the first encryption key or the second encryption key, the encrypted data file from the first computing system stored on the backup device if the second encryption key matches the first encryption key stored on the backup device.

3. The method of claim 1, further comprising storing the first encryption key on an external source.

4. The method of claim 3, further comprising:
locating, on a second computing system, identification unique to the second computing system;
creating a second encryption key using the located second computing system unique identification;
obtaining the first encryption key from the external source, if the second encryption key does not match the first encryption key stored on the backup device; and
decrypting, using the obtained first encryption key, the encrypted data file from the first computing system stored on the backup device.

5. The method of claim 4, further comprising:
storing the second encryption key on the backup device;
encrypting, using the second encryption key, a data file from the second computing system; and
storing the encrypted data file from the second computing system on the backup device.

6. The method of claim 1 wherein the first computing system is a personal computer.

7. The method of claim 1 wherein locating, on a first computing system, identification unique to the first computing system comprises reading a serial number of the first computing system.

8. The method of claim 1 wherein locating, on a first computing system, identification unique to the first computing system comprises reading a serial number of a component of the first computing system.

9. The method of claim 1 wherein locating, on a first computing system, identification unique to the first computing system comprises reading a serial number of an operating system of the first computing system.

10. The method of claim 1 wherein storing the first encryption key on a backup device comprises storing the first encryption key on a hard disk.

11. The method of claim 1 wherein storing the first encryption key on a backup device comprises storing the first encryption key on an optical disc.

12. The method of claim 1 wherein storing the first encryption key on a backup device comprises storing the first encryption key on a flash memory.

13. The method of claim 3 wherein storing the first encryption key on an external source comprises storing the first encryption key on a removeable storage device.

14. The method of claim 3 wherein storing the first encryption key on an external source comprises storing the first encryption key on a flash memory.

15. The method of claim 3 wherein storing the first encryption key on an external source comprises storing the first encryption key on another computing system coupled to the first computing system via a computer network.

16. The method of claim 4 wherein storing the first encryption key on an external source comprises storing the first encryption key on the second computing system, the second computing system coupled to the first computing system via a computer network, and wherein obtaining the first encryption key from the external source comprises reading the stored first encryption key from the second computing system.

17. A computer readable medium having stored thereupon computing instructions comprising:
a code segment to locate, on a first computing system, identification unique to the first computing system;
a code segment to create a first encryption key using the located first computing system unique identification;
a code segment to store the first encryption key on a backup device;
a code segment to encrypt, using the first encryption key, a data file from the first computing system; and
a code segment to store the encrypted data file from the first computing system on the backup device.

18. A backup device comprising:
a computer readable medium having stored thereupon computing instructions including:
a code segment to locate, on a first computing system, identification unique to the first computing system;
a code segment to create a first encryption key using the located first computing system unique identification;
a code segment to store the first encryption key on a backup device;
a code segment to encrypt, using the first encryption key, a data file from the first computing system; and
a code segment to store the encrypted data file from the first computing system on the backup device.

19. The backup device of claim 18 wherein the computer readable medium further comprises having stored thereupon computing instructions including:
a code segment to locate again, on the first computing system, identification unique to the first computing system;
a code segment to create a second encryption key using the again located computing system unique identification; and
a code segment to decrypt, using either the first encryption key or the second encryption key, the encrypted data file from the first computing system stored on the backup device if the second encryption key matches the first encryption key stored on the backup device.

20. The backup device of claim 18 wherein the computer readable medium further comprises having stored thereupon computing instructions including a code segment to store the first encryption key on an external source.

21. The backup device of claim 20 wherein the computer readable medium further comprises having stored thereupon computing instructions including:
a code segment to locate, on a second computing system, identification unique to the second computing system;
a code segment to create a second encryption key using the located second computing system unique identification;
a code segment to obtain the first encryption key from the external source, if the second encryption key does not match the first encryption key stored on the backup device; and
a code segment to decrypt, using the obtained first encryption key, the encrypted data file from the first computing system stored on the backup device.

22. The backup device of claim 21 wherein the computer readable medium further comprises having stored thereupon computing instructions including:
a code segment to store the second encryption key on the backup device;
a code segment to encrypt, using the second encryption key, a data file from the second computing system; and
a code segment to store the encrypted data file from the second computing system on the backup device.

23. The backup device of claim 18 wherein the computer readable medium is a hard disk.

24. The backup device of claim 18 wherein the computer readable medium is an optical disc.

25. The backup device of claim 18 wherein the computer readable medium is a flash memory.
